(19) United States
(12) Patent Application Publication
(10) Pub. No.: US 2022/0164742 A1
(43) Pub. Date: May 26, 2022

(54) METHOD FOR DETERMINING CODE SIMILARITY OF AN OPEN SOURCE PROJECT AND A COMPUTER-READABLE MEDIUM STORING A PROGRAM THEREOF

(71) Applicant: RESEARCH & BUSINESS FOUNDATION SUNGKYUNKWAN UNIVERSITY, Suwon-si (KR)

(72) Inventors: Hyoung Shick KIM, Suwon-si (KR); Ju Sop CHOI, Suwon-si (KR)

(73) Assignee: RESEARCH & BUSINESS FOUNDATION SUNGKYUNKWAN UNIVERSITY, Suwon-si (KR)

(21) Appl. No.: 17/533,743

(22) Filed: Nov. 23, 2021

(30) Foreign Application Priority Data
Nov. 24, 2020 (KR) 10-2020-0159191

(51) Int. Cl. G06Q 10/06; G06F 11/36

(52) U.S. Cl. CPC G06Q 10/06313; G06F 11/3608

(57) ABSTRACT

Provided is a method for determining a code similarity of an open source project, which includes: a similarity detecting step of detecting, by a similarity calculation unit, similarities between A commits generated every update of a first project and B commits generated every update of a second project; a highest similarity determining step of detecting, by a Fork determination unit, a highest similarity between the A commits and the B commits and a similar commit pair representing the highest similarity; and a Fork determining step of determining, by the Fork determination unit, a Fork time based on an update time of the similar commit pair when the highest similarity is equal to or more than a predetermined threshold.

### CROSS-REFERENCE TO RELATED APPLICATION

This application claims the benefit under 35 USC § 119(a) of Korean Patent Application No. 10-2020-0159191, filed on Nov. 24, 2020 in the Korean Intellectual Property Office, the entire disclosure of which is incorporated herein by reference for all purposes.

### BACKGROUND

### Field of the Disclosure

The present disclosure relates to a method for determining a code similarity of an open source project and a computer-readable medium storing a program thereof, and particularly, to being capable of more accurately determining a fork time and whether plagiarism is made.

### Related Art

GitHub in which a lot of open source projects are uploaded and managed may modify and process another project through a function such as Fork.

However, a new project is created in a state in which an actual source project cannot be known by downloading a project code, and then uploading the project code without using such a Fork function to plagiarize the project.

Further, when a code of one project is significantly changed through active development in two projects having the same code, if a similarity is evaluated only with a released code, accurate similarity measurement is impossible.

For example, when a code of project a is significantly changed through frequent update within a predetermined time after the code of project a is replicated by project b, even though project b replicates the code of project a by a general similarity measurement technique, the similarity between project a and project b decreases, and as a result, it is difficult to determine whether the project is plagiarized.

### SUMMARY

The present disclosure provides accurately determining whether another project is replicated with an arbitrary project.

The present disclosure also provides more accurately determining a replication timing of a project.

In an aspect, provided is a method for determining a code similarity of an open source project, which includes: a similarity detecting step of detecting, by a similarity calculation unit, similarities between A commits generated every update of a first project and B commits generated every update of a second project; a highest similarity determining step of detecting, by a Fork determination unit, a highest similarity between the A commits and the B commits and a similar commit pair representing the highest similarity; and a Fork determining step of determining, by the Fork determination unit, a Fork time based on an update time of the similar commit pair when the highest similarity is equal to or more than a predetermined threshold.

According to a method for determining a code similarity of an open source project according to the present disclosure, since based on determining all similarities between projects of past versions, whether the project is replicated, it can be known which version of library open source projects process the project by utilizing.

According to the method for determining a code similarity of an open source project according to the present disclosure, since Fork performed based on a project of a previous version other than a latest project can be detected, it is possible to determine a plagiarizing action using a past project in order to intentionally hide plagiarism.

### BRIEF DESCRIPTION OF DRAWINGS

FIG. 1 is a diagram illustrating a device for determining a code similarity of an open source project according to an exemplary embodiment of the present disclosure.

FIG. 2 is a flowchart illustrating a method for determining a code similarity of an open source project according to an exemplary embodiment of the present disclosure.

FIG. 3 is a diagram for describing an exemplary embodiment of downloading commits.

FIG. 4 is a schematic diagram of a method for calculating a similarity between commits of a first project and commits of a second project.

FIGS. 5 and 6 are diagrams for describing a method for calculating a similarity of a latest replication project compared with an original project at a Fork time.

### DETAILED DESCRIPTION

Advantages and features of the present disclosure, and methods for accomplishing the same will be more clearly understood from exemplary embodiments described in detail below with reference to the accompanying drawings. However, the present disclosure is not limited to the following exemplary embodiments but may be implemented in various different forms. The exemplary embodiments are provided only to complete disclosure of the present disclosure and to fully provide a person having ordinary skill in the art to which the present disclosure pertains with the category of the disclosure, and the present disclosure will be defined only by the appended claims.

The features of various exemplary embodiments of the present disclosure can be partially or entirely coupled to or combined with each other and can be interlocked and operated in technically various ways, and the exemplary embodiments can be carried out independently of or in association with each other.

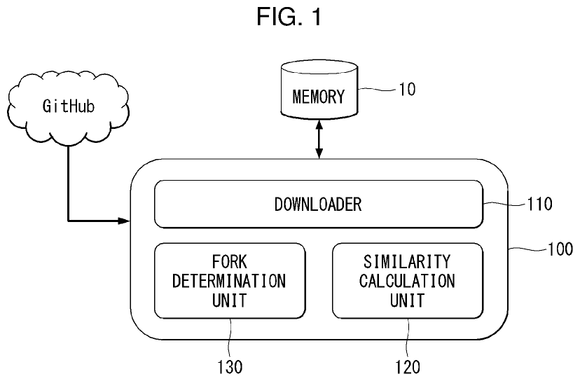

FIG. 1 is a diagram illustrating a device for determining a code similarity of an open source project according to the present disclosure.

Referring to FIG. 1, a device 100 for determining a code similarity of an open source project according to the present disclosure includes a downloader 110, a similarity calculation unit 120, and a Fork determination unit 130.

The downloader 110 downloads commits generated every update of a first project and commits generated even update of a second project. The commit is referred to as a task of adding a file or storing changed contents in a storage 10. Hereinafter, in the present disclosure, the commits of the first project will be referred to as A_commit and the commits of the second project are referred to as B_commit. The downloader 110 may perform a task of receiving a project from GitHub in a compression file form, and releasing compression.

The similarity calculation unit 120 may calculate similarities between A_commits and B_commits. The similarity calculation unit determines a commit pair having a highest value among the similarities between A_commits and B_commits as a similar commit pair, and determines the similarity of the corresponding similar commit pair as a highest similarity.

When the highest similarity is equal to or more than a predetermined first threshold, the Fork determination unit 130 may determine the Fork time based on an update time of the similar commit pair. The Fork determination unit 130 may determine an update time of a late timing in the similar commit pair as the Fork time.

Hereinafter, the method for determining the code similarity of the open source project according to the present disclosure will be described below in more detail.

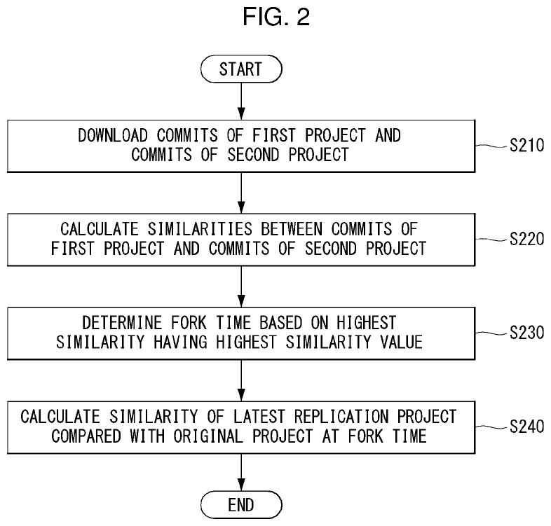

FIG. 2 is a flowchart illustrating a method for determining a code similarity of an open source project according to an exemplary embodiment of the present disclosure.

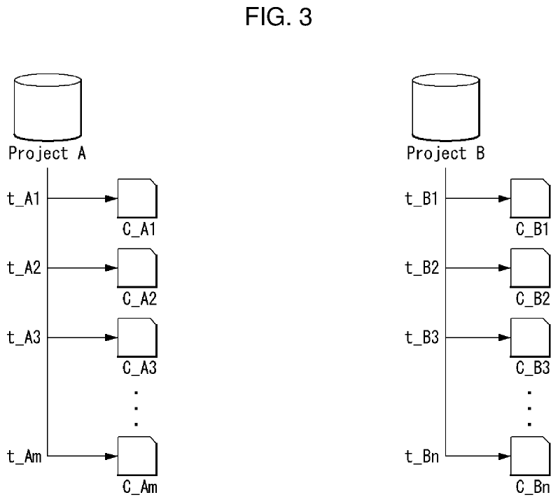

Referring to FIG. 2, in the method for determining a code similarity of an open source project according to an exemplary embodiment of the present disclosure, in a first step (S210), a downloader 110 downloads commits of a first project and commits of a second project. The first step (S210) illustrated in FIG. 2 will be described below with reference to FIG. 3.

FIG. 3 is a diagram for describing an exemplary embodiment of downloading commits by a downloader.

Referring to FIG. 3, the downloader 110 is downloaded with all commits generated whenever a first project Project A is updated, i.e., first to m (m is a natural number)-th A commits C_A1 to C_Am. Likewise, the downloader 110 is downloaded with all commits generated whenever a second project (Project B) is updated, i.e., first to n (n is a natural number)-th B commits C_B1 to C_Bn.

A first A time t_A1 is a time when the first project Project A is updated and the first A commit C_A1 is generated. Likewise, a second A time t_A2 to an m-th A time t_Am are a time when the first project Project A is updated, and a second A commit C_A2 to the m-th A commit C_Am are generated. Likewise, a first B time t_B1 to an n-th B time t_Bn are a time when the second project Project B is updated, and first to n-th B commits C_B1 to C_Bn are generated.

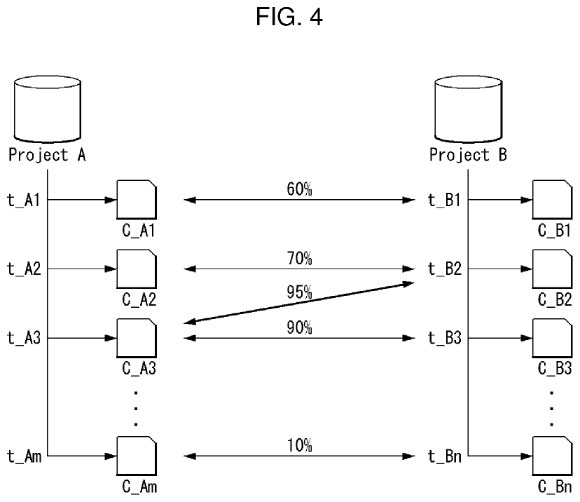

Referring back to FIG. 2, the method for determining a code similarity of an pen source project according to an exemplary embodiment of the present disclosure includes calculating, by the similarity calculation unit 120, similarities between the first to m-th A commits C_A1 to C_Am and the first to n-th B commits C_B1 to C_Bn in the second step (S220). The second step (S220) of FIG. 2 will be described below with reference to FIG. 4.

FIG. 4 is a schematic diagram of a method for calculating similarities between commits of a first project and commits of a second project.

Referring to FIG. 4, the similarity calculation unit 120 detects similarities of respective first to m-th A commits C_A1 to C_Am and respective first to n-th B commits C_B1 to C_Bn to acquire “m×n” similarities.

Referring back to FIG. 2, the method for determining a code similarity of an open source project according to an exemplary embodiment of the present disclosure includes a Fork determination step of calculating a highest similarity, and comparing the highest similarity and a first threshold, and determining the Fork time by the Fork determination unit 130 in the third step (S230). The first threshold may be configured according to a criterion for determining a replicability.

The Fork determination unit 130 calculates a similarity having a highest value among the similarities between the respective first to m-th A commits C_A1 to C_Am and the respective first to n-th B commits C_B1 to C_Bn, and determines a commit pair representing a highest similarity as a similar commit pair. For example, in FIG. 4, when the similarity between the third A commit C_A3 and the second B commit C_B2 has a highest value as “95”(%), the Fork determination unit 130 calculates the highest similarity as “95”. In addition, the Fork determination unit 130 determines the third A commit C_A3 and the second B commit C_B2 as the similar commit pair.

In addition, the Fork determination unit 130 may determine an update time of a late timing in the similar commit pair as the Fork time. For example, in FIG. 4, if a time when the third A commit C_A3 is generated is later than a time when the second B commit C_B2 is generated, the Fork determination unit 130 determines the third A time t_A3 when the third A commit C_A3 is generated as the Fork time. Alternatively, if the time when the third A commit C_A3 is generated is earlier than the time when the second B commit C_B2 is generated, the Fork determination unit 130 determines the second B time t_B2 when the second B commit C_B2 is generated as the Fork time.

In addition, the Fork determination unit 130 determines a project that generates an early updated commit as an original project, and a project that generates a later updated commit as a replication project, in the similar commit pair.

According to the method for determining a code similarity of an open source project according to the present disclosure as such, since Fork performed based on a project of a previous version other than a latest project may be detected, it is possible to determine a plagiarizing action using a past project in order to intentionally hide plagiarism.

Referring back to FIG. 2, in the method for determining a code similarity of an open source project according to an exemplary embodiment of the present disclosure, in the fourth step (S240), the Fork determination unit 130 calculates similarity of a latest replication project compared with an original project at the Fork time to determine whether the replication project compared with the original project is plagiarized. To this end, the Fork determination unit 130 may compare the similarity between the commit at the Fork time of the original project and the latest commit of the replication project.

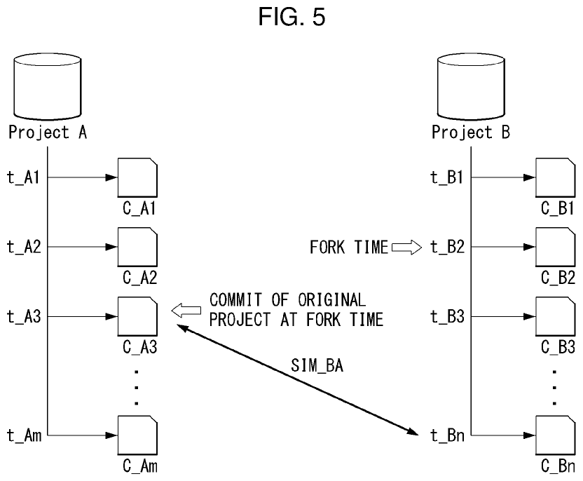

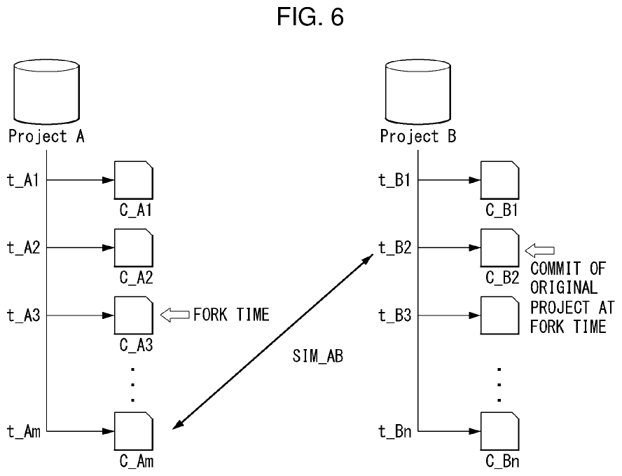

FIGS. 5 and 6 are diagrams for describing a method for calculating a similarity of a latest replication project compared with an original project at a Fork time.

In FIG. 5, reference numeral “SIM_BA” denotes a similarity of a replicated second project compared with a first project which is an original project, and in FIG. 6, reference numeral “SIM_AB” denotes a similarity of a replicated first project compared with a second project which is the original project.

Referring to FIG. 5, the Fork determination unit 130 searches a commit of the original project at the Fork time. For example, as in FIG. 4, when the third A commit C_A3 and the second B commit C_B2 are determined as the similar commit pair, and the second B time t_B2 is determined as the Fork time, the second project Project B is determined as the replication project.

When the Fork time is determined to be the second B time t_B2, the Fork time is positioned between the third A time t_A3 and the fourth A time t_A4. Accordingly, the commit of the original project at the Fork time corresponds to the third A commit C_A3 generated at the 3A time t_A3.

In addition, a latest commit of the replication project corresponds to the n-th B commit C Bn.

Consequently, the Fork determination unit 130 compares a similarity between the third A commit C_A3 and the n-th B commit C_Bn as the similar commit pair. When the similarity between the third A commit C_A3 and the n-th B commit C_Bn is equal to or more than a predetermined second threshold, the Fork determination unit 130 may determine that the second replication project is plagiarized as compared with the original project. The second threshold may be configured according to a criterion for determining a replicability. Due to characteristics of GitHub which is an open source, after the original project is forked, the replication project may be processed again and may become a new project. However, when the similarity of the latest replication project compared with the original project at the Fork time is high, it may be determined that the replication project is not almost reprocessed after the Fork time.

Referring to FIG. 6, the Fork determination unit 130 searches the commit of the original project at the Fork time. When the third A commit C_A3 and the second B commit C_B2 are determined as the similar commit pair, and the third A time t_A3 is determined as the Fork time, the first project Project A is determined as the replication project.

When the Fork time is determined to be the third A time t_A3, the Fork time is positioned between the second B time t_B2 and the third B time t_B3. Accordingly, the commit of the original project at the Fork time corresponds to the second B commit C_B2 generated at the 2B time t_B2.

In addition, the latest commit of the replication project corresponds to the m-th A commit C_Am.

Consequently, the Fork determination unit 130 compares a similarity between the second B commit C_B2 and the m-th A commit C_Am.

As a result of examining similarities between 518 respective cryptocurrencies and bitcoins which are developed a lot by an open source project by using an exemplary embodiment of the present disclosure, it is confirmed that 159 cryptocurrencies have a similarity of 92.9% or more at a branch time.

Further, a similarity between latest versions is very low as 33.2%, but as a result of measuring the similarity based on an exemplary embodiment of the present disclosure, it is confirmed that the latest versions has a very high similarity as 98.4%. In addition, as a result of confirming an actual code, it is confirmed that most codes are similar, and as a result, the reliability of a similarity measurement method based on an exemplary embodiment of the present disclosure is verified.

The exemplary embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Further, in the case of implementation by firmware or software, the exemplary embodiment of the present disclosure may be implemented in the form of a module, a procedure, a function, and the like to perform the functions or operations described above and recorded in recording media readable by various computer means. Herein, the recording medium may include singly a program command, a data file, or a data structure or a combination thereof. The program command recorded in the recording medium may be specially designed and configured for the present disclosure, or may be publicly known to and used by those skilled in the computer software field. Examples of the computer-readable recording medium include magnetic media such as a hard disk, a floppy disk, and a magnetic tape, optical media such as a CD-ROM and a DVD, magneto-optical media such as a floptical disk, and a hardware device which is specifically configured to store and execute the program command such as a ROM, a RAM, and a flash memory. An example of the program command includes a high-level language code executable by a computer by using an interpreter and the like, as well as a machine language code created by a compiler. The hardware devices may be configured to operate as one or more software modules in order to perform the operation of the present disclosure, and an opposite situation thereof is available.

In addition, an apparatus or terminal according to the present disclosure may be driven by commands that cause one or more processors to perform the functions and processes described above. The commands may include, for example, interpreted commands such as script commands, such as JavaScript or ECMAScript commands, executable codes or other commands stored in computer readable media. Further, the apparatus according to the present disclosure may be implemented in a distributed manner across a network, such as a server farm, or may be implemented in a single computer device.

In addition, a computer program (also known as a program, software, software application, script or code) that is embedded in the apparatus according to the present disclosure and which implements the method according to the present disclosure may be prepared in any format of a compiled or interpreted language or a programming language including a priori or procedural language and may be deployed in any format including standalone programs or modules, components, subroutines, or other units suitable for use in a computer environment. The computer program does not particularly correspond to a file in a file system. The program may be stored in a single file provided to a requested program, in multiple interactive files (e.g., a file storing one or more modules, subprograms, or portions of code), or in a part (e.g., one or more scripts stored in a markup language document) of a file storing another program or data. The computer program may be positioned in one site or distributed throughout a plurality of sites and extended to be executed on multiple computers interconnected by a communication network or one computer.

It will be apparent to those skilled in the art that various changes and modifications can be made without departing from the technical spirit of the present disclosure through contents described above. Therefore, the technical scope of the present disclosure should not be limited to the contents described in the detailed description of the present disclosure but should be defined by the claims.

What is claimed is:

1. A method for determining a code similarity of an open source project, the method comprising:
a similarity detecting step of detecting, by a similarity calculation unit, similarities between A commits generated every update of a first project and B commits generated every update of a second project;
a highest similarity determining step of detecting, by a Fork determination unit, a highest similarity between the A commits and the B commits and a similar commit pair representing the highest similarity; and
a Fork determining step of determining, by the Fork determination unit, a Fork time based on an update time of the similar commit pair when the highest similarity is equal to or more than a predetermined threshold.

2. The method of claim 1, wherein the similarity calculating step includes
storing first to m-th A commits according to m (m is a natural number) updates by storing the commit generated every update of the first project,
storing first to n-th B commits according to n (n is the natural number) updates by storing the commit generated every update of the second project, and
acquiring “m×n” similarities by detecting similarities between the respective first to m-th A commits and the respective first to n-th B commits.

3. The method of claim 1, wherein in the Fork determining step, an update time of a late timing is determined as the Fork time in the similar commit pair.

4. The method of claim 3, wherein in the Fork determining step, a project that generates an early updated commit is determined as an original project, and a project that generates a later updated commit is determined as a replication project, in the similar commit pair.

5. The method of claim 4, wherein the Fork determining step further includes calculating a similarity of a latest replication project compared with the original project at the Fork time.

6. A computer-readable medium storing a program of a method for determining a code similarity of an open source project, comprising:
a similarity detecting step of detecting similarities between A commits generated every update of a first project and B commits generated every update of a second project;
a highest similarity determining step of detecting a highest similarity between the A commits and the B commits and a similar commit pair representing the highest similarity; and
a Fork determining step of determining a Fork time based on an update time of the similar commit pair when the highest similarity is equal to or more than a predetermined threshold.
